(19) United States
(12) Patent Application Publication
(10) Pub. No.: US 2018/0178596 A1
(43) Pub. Date: Jun. 28, 2018

(54) TIRE HAVING A CONDUCTIVE INSERT

(71) Applicant: Bridgestone Americas Tire Operations, LLC, Nashville, TN (US)

(72) Inventors: James M. KIRBY, Akron, OH (US); Emily A. DEMETER, Aiken, SC (US); David J. ZEMLA, Canal Fulton, OH (US)

(21) Appl. No.: 15/735,968

(22) PCT Filed: May 20, 2016
(86) PCT No.: PCT/US16/33417

§ 371 Date: Dec. 13, 2017

Related U.S. Application Data
(60) Provisional application No. 62/175,489, filed on Jun. 15, 2015.

(51) Int. Cl. B60C 19/08

(52) U.S. Cl. CPC B60C 19/084; B60C 19/088

(57) ABSTRACT

A tire includes a body ply extending from a first bead region to a second bead region and a conductive ply disposed radially above the body ply. The tire further includes a gum strip having a top end in contact with the conductive ply and a bottom end located in the first bead region.

### FIELD OF INVENTION

The present disclosure is directed to tires and tire treads featuring conductivity paths for conducting electric charge. More particularly, the present disclosure is directed to tires having a conductive substance disposed along a body ply.

### BACKGROUND

Known tires contain materials that inhibit the conduction of electric charge. For example, tires having relatively high amounts of silica are known to accumulate static charge, which is undesirable for vehicle operation. Tires having relatively high amounts of silica previously used antennas to dissipate charge.

### SUMMARY OF THE INVENTION

In one embodiment, a tire includes a pair of bead regions, including a first bead region and a second bead region. The tire further includes a pair of sidewall regions, including a first sidewall region disposed above the first bead region and a second sidewall region disposed above the second bead region. The tire also has a crown region extending from the first sidewall region to the second sidewall region, and at least one body ply extending from the first bead region, through the pair of sidewall regions and crown region, to the second bead region. The tire also includes at least one circumferential belt in the crown region, disposed radially above the at least one body ply. At least one cap ply is located in the crown region, radially above the at least one circumferential belt. The tire further includes at least one cap ply insert that has a center portion disposed radially above the at least one circumferential belt. The at least one cap ply insert has a pair of end portions including a first end portion and a second end portion, and each of the pair of end portions extend radially below the at least one circumferential belt. The tire also includes a gum strip at least partially disposed in the first sidewall region. The gum strip has a top end disposed between the at least one body ply and the at least one cap ply insert and a bottom end located in the first bead region.

In another embodiment, a tire includes a first bead having a first bead core and a first bead filler, and a second bead having a second bead core and a second bead filler. The tire also has a body ply extending from the first bead to the second bead. The body ply has a first turn up portion that wraps around the first bead core and at least partially wraps around the first bead filler, and a second turn up portion that wraps around the second bead core and at least partially wraps around the second bead filler. The tire further includes a circumferential belt disposed radially above the body ply. The circumferential belt has a belt width defined by a first belt end and a second belt end. The tire also includes a conductive ply having a central portion disposed radially above the circumferential belt. The conductive ply has a conductive ply width defined by a first conductive ply end and a second conductive ply end. The conductive ply width is greater than the belt width. The tire further includes a gum strip having a first end radially above the first conductive ply end and a second end radially below a top of the first bead filler.

In yet another embodiment, a tire includes a body ply extending from a first bead region to a second bead region and a conductive ply disposed radially above the body ply. The tire further includes a gum strip having a top end in contact with the conductive ply and a bottom end located in the first bead region.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a schematic drawing showing certain elements of a half section of one embodiment a tire;

FIG. 2 is a more detailed cross-section of a quarter section of the tire of FIG. 1; and

FIG. 3 is a cross-section of a bead region and sidewall region of the tire shown in FIGS. 1 and 2.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Axial” and “axially” refer to a direction that is parallel to the axis of rotation of a tire.

“Circumferential” and “circumferentially” refer to a direction extending along the perimeter of the surface of the tread perpendicular to the axial direction.

“Radial” and “radially” refer to a direction perpendicular to the axis of rotation of a tire.

“Sidewall” as used herein, refers to that portion of the tire between the tread and the bead.

“Tread” as used herein, refers to that portion of the tire that comes into contact with the road or ground under normal inflation and normal load.

While similar terms used in the following descriptions describe common tire components, it is understood that because the terms carry slightly different connotations, one of ordinary skill in the art would not consider any one of the following terms to be purely interchangeable with another term used to describe a common tire component.

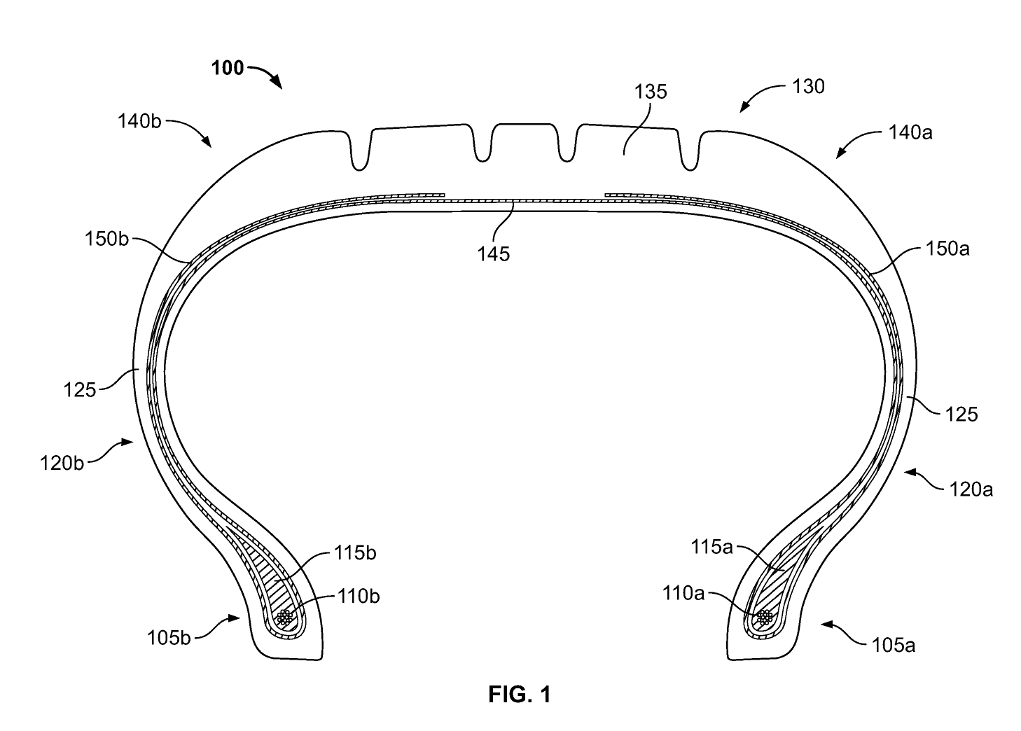

FIG. 1 is a schematic drawing of a half section of a tire 100. The tire 100 includes a pair of bead regions 105a,b, including a first bead region 105a and a second bead region 105b. Each bead region 105a,b includes a bead core 110a,b and a bead filler 115a,b. In the illustrated embodiment, each bead filler 115a,b is shown as a single component. In an alternative embodiment (not shown), the bead fillers are formed of two or more components of different material. In another alternative embodiment (not shown), the bead filler is omitted.

The tire 100 further includes a pair of sidewall regions 120a,b. A first sidewall region 120a is located above the first bead region 105a and a second sidewall region 120b is located above the second bead region 105b. Each of the sidewall regions 120a,b includes sidewall rubber 125.

The tire 100 also includes a crown region 130 extending from the first sidewall region 120a to the second sidewall region 120b. The crown region 130 includes a circumferential tread 135. The circumferential tread may include ribs, blocks, lugs, grooves, sipes, or other tread elements.

A first shoulder region 140a is a transition region between the first sidewall region 120a and the crown region 130. A second shoulder region 140b is a transition region between the second sidewall region 120b and the crown region 130.

A body ply 145 extends from the first bead region 105a, through the pair of sidewall regions 120 and crown region 130, to the second bead region 105b. The body ply 145 has a first turn up portion 150a and a second turn up portion 150b. In the illustrated embodiment, the first turn up portion 150a wraps around a first bead core 110a and a first bead filler 115a, extends through the first sidewall region 120a and first shoulder region 140a, and terminates in the crown region 130. Likewise, the second turn up portion 150b wraps around a second bead core 110b and a second bead filler 115b, extends through the second sidewall region 120b and second shoulder region 140b, and terminates in the crown region 130. In alternative embodiments (not shown), the first and second turn up portions terminate in the shoulder regions or sidewall regions of the tire. In another alternative embodiment (not shown), the first and second turn up portions terminate in the bead regions. In such an embodiment, the turn up portions may only partially wrap around the bead fillers or the bead cores.

While only a single body ply is shown, it should be understood that multiple body plies may be employed. In such an embodiment, the turn up ends of the different body plies may terminate at different locations.

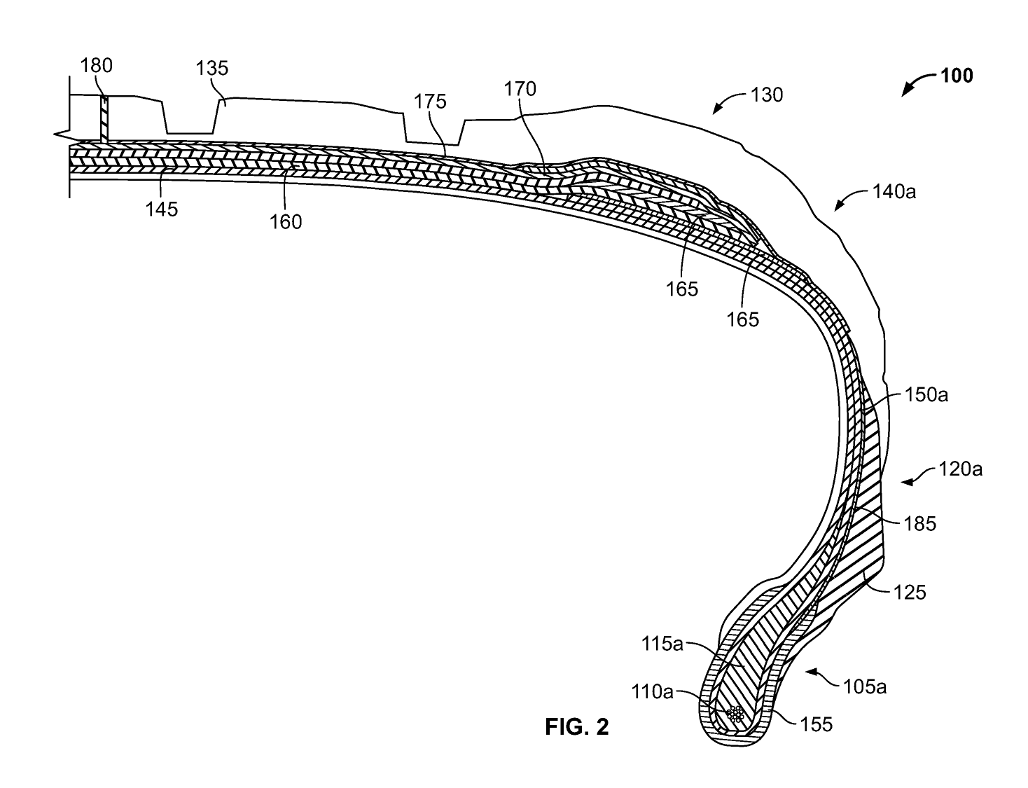

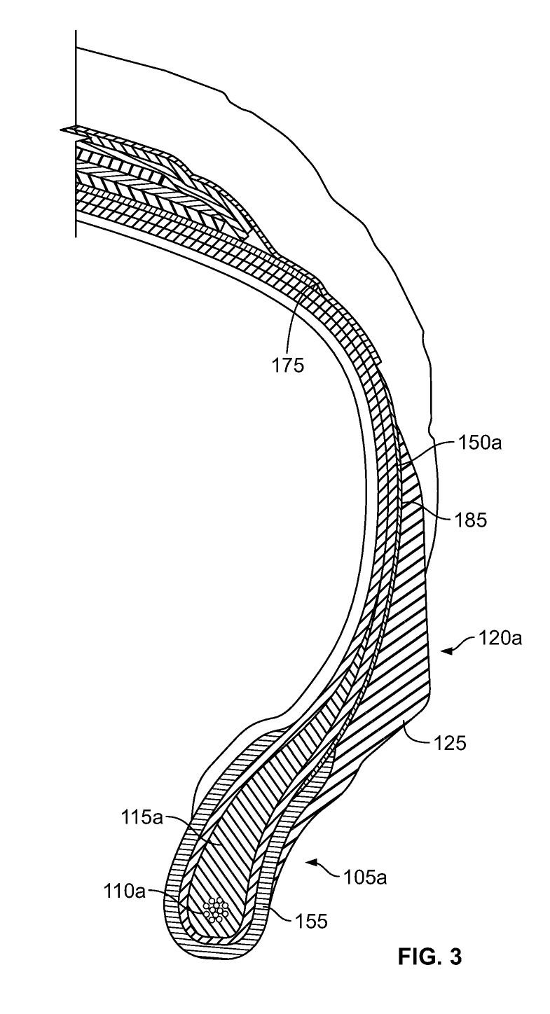

FIG. 2 is a more detailed cross-section of a quarter section of the tire 100. Additional details can be seen in FIG. 3, which is a cross-section of a bead region and sidewall region of the tire shown in FIG. 2. The remaining components will be discussed with reference to both FIGS. 2 and 3.

Each bead region further includes an abrasion 155. While only the first abrasion 155 of the first bead region 105a is shown in FIGS. 2 and 3, it should be understood that the second bead region 105b includes a similar abrasion. Each abrasion 155 is constructed of a relatively conductive compound that allows electric charge to leave tire 100. For example, the abrasion may have a resistivity of between 2×10⁵ Ω-cm and 5×10⁵ Ω-cm. In one particular embodiment, the abrasion has a resistivity of 3.5×10⁵ Ω-cm.

Each abrasion 155 wraps around the bead core 105 and partially wraps around the bead filler 110. In an alternative embodiment (not shown), the abrasion does not wrap around the bead core, and does not extend to the inside of the bead region.

In the illustrated embodiment, an outer portion of each abrasion 155 abuts the sidewall rubber 125. In an alternative embodiment (not shown), one or more additional rubber regions may be disposed between the abrasion and the sidewall rubber.

With continued reference to FIG. 2, circumferential belts 160 are disposed in the crown region 130, radially above the body ply 145. The circumferential belts 160 have a belt width defined by a first end and a second end (not shown in this view). In the illustrated embodiment, two circumferential belts are employed. When multiple belts of different dimensions are employed, the belt width is the width of the longest belt. The circumferential belts may be constructed of steel or another metal. In an alternative embodiment, the circumferential belts may be constructed of nylon or a non-metal polymer. While two circumferential belts are shown in the illustrated embodiment, it should be understood that any number of belts may be employed.

A belt edge insert 165 is disposed under the edge of each belt 160. In alternative embodiments, one or more of the belt edge inserts may be omitted.

Cap plies 170 are also disposed in the crown region 130 of the tire 100. The cap plies 170 have a central portion located radially above the circumferential belts 160. The cap plies 170 have a cap ply width defined by a first end and a second end (not shown in this view). In the illustrated embodiment, the ends of the cap plies 170 are radially below an upper belt, and have substantially the same radial elevation as a lower belt. However, it should be understood that the ends of the cap plies may be radially above or radially below the circumferential belts.

The cap plies may be constructed of nylon or another polymeric material. In the illustrated embodiment, two cap plies are employed. When multiple cap plies are employed, the cap ply width is the width of the longest cap ply. While two circumferential cap plies are shown in the illustrated embodiment, it should be understood that any number of cap plies may be employed. Alternatively, the cap plies may be omitted entirely.

A cap ply insert 175 is also disposed in the crown region 130. The cap ply insert 175 has a center portion disposed radially above the cap plies 170 and the circumferential belts 160. The cap ply insert 175 has a first end portion and a second end portion (not shown) that define a cap ply insert width. The cap ply insert 175 width is greater than the belt width and greater than the cap ply width. The width of the cap ply insert 175 is such that the cap ply insert extends into the shoulder regions 140. The cap ply insert 175 may even extend into the sidewall regions 120. Both the first end portion and the second end portion of the cap ply insert 175 extend radially below the circumferential belts 160. The cap ply insert 175 is constructed of a relatively conductive compound that allows electric charge to leave tire 100. Therefore, the cap ply insert 175 may also be referred to as a conductive ply. For example, the cap ply insert may have a resistivity of between 4×10⁷ Ω-cm and 7×10⁷ Ω-cm. In one particular embodiment, the cap ply insert has a resistivity of 5.5×10⁷ Ω-cm.

An antenna 180 is disposed in a portion of the circumferential tread 135. In the illustrated embodiment, the antenna 180 is disposed in a middle rib, but it is not limited to a particular location on the tread, and multiple antennas can be used. Antenna 180 extends from the tread surface to the cap ply insert 175. The antenna 180 is constructed of a relatively conductive compound that allows electric charge to leave tire 100. For example, the antenna may have a resistivity of between 1×10⁵ Ω-cm and 4×10⁵ Ω-cm. In one particular embodiment, the abrasion has a resistivity of 2.5×10⁵ Ω-cm. In one embodiment, the conductive antenna has a width between 3-6% of the tread width. In another embodiment, the tire lacks a conductive antenna.

A gum strip 185 is at least partially disposed in the first sidewall region 120a, such that a middle section of the gum strip 185 is disposed between the body ply 145 and the sidewall rubber 125 of the first sidewall region 120a. More specifically, the middle section of the gum strip 185 is disposed between the first turn up portion 150a of the body ply 145 and the sidewall rubber 125 of the first sidewall region 120a.

A top end of the gum strip 185 may extend to the first shoulder region 140a, or it may terminate in the first sidewall region 120a. The top end of the gum strip 185 is disposed between the body ply 145 and the cap ply insert 175. In the illustrated embodiment, the top end of the gum strip 185 is disposed between the cap ply insert 175 and the first turn up portion 150a of the body ply 145. In an alternative embodiment (not shown), the top end of the gum strip is disposed between the cap ply insert and a main portion of the body ply. In another alternative embodiment (not shown), the top end of the gum strip is disposed between the cap ply insert and the sidewall rubber.

A bottom end of the gum strip 185 is located in the first bead region 105a. More particularly, the bottom end of the gum strip 185 is located radially below a top end of the first bead filler 115a. In an alternative embodiment (not shown), the bottom end of the gum strip terminates in the first sidewall region.

In the illustrated embodiment, the bottom end of the gum strip 185 is disposed between the first abrasion 155 and the first turn up portion 150a of the body ply 145. In an alternative embodiment (not shown), the bottom end of the gum strip is disposed between the first abrasion and the first bead filler. In another alternative embodiment (not shown), the bottom end of the gum strip is disposed between the first abrasion and the sidewall rubber. In yet another alternative embodiment (not shown), the bottom end of the gum strip is disposed between the body ply and the sidewall rubber.

The gum strip 185 has substantially the same thickness throughout. In one embodiment, the gum strip 185 is only disposed on one side of the tire. The gum strip 185 may extend circumferentially about the tire, or it may be a single strip of material. In one known embodiment, the gum strip has a width of less than 4 centimeters. Where the gum strip is a strip of material, it may be desirable to employ multiple gum strips about the tire. In such case, each gum strip would have substantially the same orientation. For example, both a first and second gum strip could have a top end disposed between the body ply and the at least one cap ply insert and a bottom end located in the first bead region. Where two or more gum strips are employed on the same side of the tire, they may be spaced at equal intervals about the circumference of the tire, or they may be spaced at irregular intervals. In an alternative embodiment (not shown), gum strips are disposed on both sides of the tire.

The gum strip 185 is constructed of a relatively conductive compound that allows electric charge to leave tire 100. In one known embodiment, the gum strip 185 has a volume resistivity between 1×10⁵ Ω-cm and 5×10⁵ Ω-cm. An exemplary gum strip has a 300% modulus of between 10-15 MPA, an elongation strain at break of 400-450%, a tensile strain at break of 15-20 MPA, a tensile stress at break of 0.55-1 MPA and a picma tack of 12-16 N. However, it should be understood that these values are merely exemplary, and gum strips having other material properties may be employed.

In the illustrated embodiment, the antenna 180 is in direct contact with the cap ply insert 175, which is in direct contact with the gum strip 185, which is in direct contact with the first abrasion 155. Thus, the antenna 180, cap ply insert 175, gum strip 185, and the first abrasion 155 form a conductive path from the ground to a wheel. In alternative embodiments (not shown), other layers or tire components are located between some of the above-identified elements. In other words, the above-identified elements may be in indirect contact with each other. In another alternative embodiment (not shown), the antenna is omitted, and the conductive path leads from the abrasion, to the gum strip, to the cap ply insert, to the circumferential tread of the tire.

As one of ordinary skill in the art would understand, the tire embodiments described in this disclosure may be configured for use on a vehicle selected from the group consisting of motorcycles, tractors, agricultural vehicles, lawnmowers, golf carts, scooters, airplanes, military vehicles, passenger vehicles, hybrid vehicles, high-performance vehicles, sport-utility vehicles, light trucks, heavy trucks, heavy-duty vehicles, and buses. One of ordinary skill in the art would also understand that the embodiments described in this disclosure may be utilized with a variety of tread patterns, including, without limitation, symmetrical, asymmetrical, directional, studded, and stud-less tread patterns. One of ordinary skill in the art would also understand that the embodiments described in this disclosure may be utilized, without limitation, in high-performance, winter, all-season, touring, non-pneumatic, and retread tire applications.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present disclosure has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the disclosure, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A tire comprising:
a pair of bead regions, including a first bead region and a second bead region;
a pair of sidewall regions, including a first sidewall region disposed above the first bead region and a second sidewall region disposed above the second bead region;
a crown region extending from the first sidewall region to the second sidewall region;
at least one body ply extending from the first bead region, through the pair of sidewall regions and crown region, to the second bead region;
at least one circumferential belt in the crown region, disposed radially above the at least one body ply;
at least one cap ply in the crown region, disposed radially above the at least one circumferential belt;
at least one cap ply insert,
wherein the at least one cap ply insert has a center portion disposed radially above the at least one circumferential belt, and
wherein the at least one cap ply insert has a pair of end portions including a first end portion and a second end portion, each of the pair of end portions extending radially below the at least one circumferential belt; and
a gum strip at least partially disposed in the first sidewall region, the gum strip having a top end disposed between the at least one body ply and the at least one cap ply insert and a bottom end located in the first bead region.

2. The tire of claim 1, wherein the gum strip has a volume resistivity between 1×10⁵ Ω-cm and 5×10⁵ Ω-cm.

3. The tire of claim 1, wherein the first bead region includes a first bead core and a first bead filler, wherein the second bead region includes a second bead core and a second bead filler, and wherein the bottom end of the gum strip is located radially below a top end of the first bead filler.

4. The tire of claim 3, wherein the first bead region further includes a first abrasion, wherein the second bead region includes a second abrasion, and wherein the bottom end of the gum strip is disposed axially between the at least one body ply and the first abrasion.

5. The tire of claim 1, wherein a middle section of the gum strip is disposed between the at least one body ply and a rubber portion of the first sidewall region.

6. The tire of claim 1, wherein the gum strip has a width of less than 4 centimeters.

7. The tire of claim 1, further comprising a second gum strip at least partially disposed in the first sidewall region, the second gum strip having a top end disposed between the at least one body ply and the at least one cap ply insert and a bottom end located in the first bead region.

8. The tire of claim 1, wherein the second sidewall region does not include a gum strip.

9. A tire comprising:
a first bead having a first bead core and a first bead filler;
a second bead having a second bead core and a second bead filler;
a body ply extending from the first bead to the second bead,
wherein the body ply has a first turn up portion that wraps around the first bead core and at least partially wraps around the first bead filler, and
wherein the body ply has a second turn up portion that wraps around the second bead core and at least partially wraps around the second bead filler;
a circumferential belt disposed radially above the body ply, the circumferential belt having a belt width defined by a first belt end and a second belt end;
a conductive ply having a central portion disposed radially above the circumferential belt,
wherein the conductive ply has a conductive ply width defined by a first conductive ply end and a second conductive ply end, and
wherein the conductive ply width is greater than the belt width; and
a gum strip having a first end radially above the first conductive ply end and a second end radially below a top of the first bead filler.

10. The tire of claim 9, wherein the gum strip has a volume resistivity between 1×10⁵ Ω-cm and 5×10⁵ Ω-cm.

11. The tire of claim 9, wherein the first end of the gum strip is disposed between the conductive ply and the body ply.

12. The tire of claim 9, further comprising a first abrasion that at least partially wraps around the first bead and a second abrasion that at least partially wraps around the second bead.

13. The tire of claim 12, wherein the second end of the gum strip is disposed between the first abrasion and the first bead filler.

14. The tire of claim 9, further comprising a cap ply between the circumferential belt and the conductive ply.

15. The tire of claim 14, wherein the cap ply has a cap ply width greater than the belt width and less than the conductive ply width.

16. A tire comprising:
a body ply extending from a first bead region to a second bead region;
a conductive ply disposed radially above the body ply; and
a gum strip having a top end in contact with the conductive ply and a bottom end located in the first bead region.

17. The tire of claim 16, wherein the conductive ply has a volume resistivity of 4×10⁷ Ω-cm and 7×10⁷ Ω-cm.

18. The tire of claim 16, wherein the gum strip has a volume resistivity between 1×10⁵ Ω-cm and 5×10⁵ Ω-cm.

19. The tire of claim 16, further comprising a circumferential belt and a cap ply.

20. The tire of claim 16, further comprising a first abrasion located in the first bead region and a second abrasion located in the second bead region.
